(19) United States
(12) Patent Application Publication
(10) Pub. No.: US 2014/0084145 A1
(43) Pub. Date: Mar. 27, 2014

(54) OPTICAL PACKAGE WITH REMOVABLY ATTACHABLE COVER

(71) Applicant: AVAGO TECHNOLOGIES GENERAL IP (SINGAPORE) PTE. L, Singapore (SG)

(72) Inventors: Tee Khoon Guan, Penang (MY); Lum Chee Foo, Penang (MY)

(73) Assignee: Avago Technologies General IP (Singapore) Pte. Ltd., Singapore (SG)

(21) Appl. No.: 13/624,464

(22) Filed: Sep. 21, 2012

(51) Int. Cl. G01J 1/02

(52) U.S. Cl. 250/216; 250/239

(57) ABSTRACT

An optical package having a removably attachable cover and a body is disclosed. The body comprises a ridge whereas the cover comprises a ridge opposing structure. The cover may be form-fitted onto the body defining therein a compartment for receiving an optical sensor. The optical sensor may receive light from an aperture located on the cover. The cover may be secured onto the body through an interlocking structure. Depending on the application, the optical package may further comprise a radiation source, and/or an additional compartment for the radiation source. The optical package may be suitable for navigation sensors, proximity sensors, ambient optical sensors or any other optical devices.

### BACKGROUND

Optical devices, such as proximity sensors, encoders, opto-couplers, motion sensors and optical navigation sensors are commonly used in electronic appliances particularly portable electronic devices. An optical device usually comprises a radiation source and an optical sensor assembled in a package or assembly. The radiation source is configured to emit a radiation such as infrared, ultra-violet and visible light. The radiation is to be detected by the optical sensor either directly or by way of reflection from an external object. The signal detected at the optical sensor is then processed further for various purposes in accordance with the intended application. For example, consider an optical mouse used for the purpose of optical navigation application. A radiation may be illuminated towards an external surface using the radiation source such as a laser diode. Images of the illuminated navigation surface captured by the optical sensor are subsequently processed and transformed into information representing movements of the input device. On the other hand, in a proximity sensor, light is illuminated towards a location located at a predetermined distance. If an external object is present at the location, the light will be reflected and detected by the optical sensor that is configured to give an output signal indicating the presence of the external object.

A package for an optical device may include an optical sensor and a radiation source being attached to a substrate or a lead frame. The optical sensor and the radiation source are usually encapsulated in a mold compound. Reworking on the optical sensors and the radiation sources on these molded packages may be difficult. For applications using sensors having more complicated functionality, it may be desirable to have an optical package that is removably attachable without permanently sealing the package. The removably attachable package may enable reworking on the light source and the optical sensor because the package can be opened up for reworking purposes. This may reduce manufacturing complexity and cost. However, removably attachable package may be susceptible to dust contamination and reliability issues.

### BRIEF DESCRIPTION OF THE DRAWINGS

Illustrative embodiments by way of examples, not by way of limitation, are illustrated in the drawings. Throughout the description and drawings, similar reference numbers may be used to identify similar elements. The drawings are for illustrative purpose to assist understanding and may not be drawn per actual scale.

FIG. 1A illustrates an exploded isometric view of a package for an optical device;

FIG. 1B illustrates an isometric view of the package shown in FIG. 1A;

FIG. 1C illustrates a cross-sectional view of the package shown in FIG. 1B taken along line 3-3;

FIG. 1D illustrates cross-sectional views showing various alternative ways how the ridge can be implemented in the embodiment shown in FIG. 1A focusing on the compartment area;

FIG. 2 illustrates an exploded isometric view of an optical package having a dual use guiding feature;

FIG. 3 illustrates an exploded isometric view of an optical package with single compartment;

FIG. 4 illustrates how the optical package shown in FIG. 3 is mounted on a substrate;

FIG. 5 illustrates a cross-sectional view of an optical mouse using the optical package shown in FIG. 3;

FIG. 6 illustrates a partial cross-sectional view of a finger navigation sensing device using the optical package shown in FIG. 1C; and

FIG. 7 illustrates a block diagram of an optical sensor.

### DETAILED DESCRIPTION

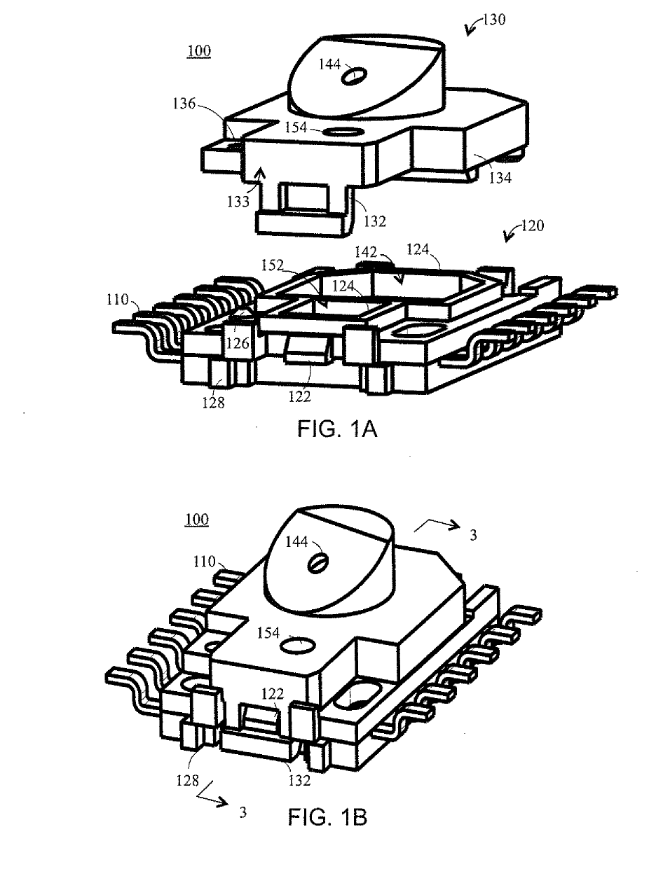

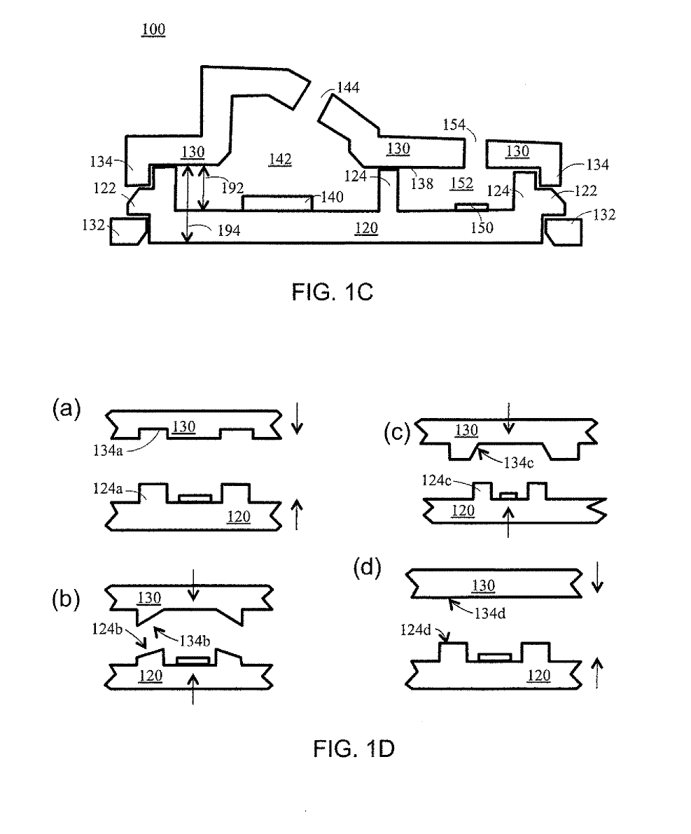

An optical device usually comprises a radiation source and an optical sensor coupled electrically through a plurality of conductors in an assembly, a package or any other means to protect components from surrounding moisture, dust or any other external substances. FIGS. 1A-1C shows an embodiment of an optical package 100. More specifically, FIG. 1A illustrates the optical package 100 shown in an exploded isometric view. An isometric view of the optical package 100 in a locked position is shown in FIG. 1B. FIG. 1C illustrates a cross-sectional view of the optical package 100 taken along line 3-3 shown in FIG. 1B. The optical package 100 shown in FIGS. 1A-1C may be used for optical navigation sensors. However, the optical package 100 may be applicable to proximity sensors, encoders, motion sensors, or other optical devices. The optical package 100 may be an optical package used in various optical devices.

Referring to FIGS. 1A-1C, the optical package 100 may comprise a plurality of leads 110, a body 120, a cover 130, an optical sensor 140 and a radiation source 150. The cover 130 is usually disposed on the body 120 and thus, the body 120 is also known as lower packaging body and the cover 130 is also known as the upper packaging cover. The plurality of leads 110 may be interconnected through a lead frame (not shown) during an initial stage of manufacturing. The body 120 may comprise an opaque encapsulant such as epoxy, plastic, ceramic or other material encapsulating a portion of the plurality of leads 110. In another embodiment using a printed circuit board (referred herein after as “PCB”), the body 120 may be a substrate such as a PCB and the plurality of leads 110 may be conductive traces of the PCB.

The radiation source 150 may be an LED die, a laser diode die or other light sources capable of emitting visible light. Alternatively, the radiation source 150 may be configured to emit invisible light such as infrared radiation and ultra-violet radiation. The optical sensor 140 may be a photodiode, phototransistor or any other device that may be configured to convert the radiation or light to an electronic signal. The optical sensor 140 may comprise a photodiode or a plurality of photodiodes arranged in rows or in pixelated matrix form. In some occasions, the optical sensor 140 may further comprise additional processing circuits.

Generally speaking, the body 120 may comprise at least one compartment 142 where at least one optical component 140 is disposed within. The at least one compartment 142 may extend into the body 120. Likewise, the compartment 142 may also extend into the cover 130 such that a cavity can be formed within the compartment 142 when the cover 130 is form-fitted onto the body 120. For integrated package where at least one optical component 140 and at least one additional optical component 150 are packaged in one single package, the body 120 may further comprise at least one additional compartment 152 for receiving the at least one additional optical component 150. In yet another embodiment, the at least one optical component 140 may be located within the at least one compartment 142 whereas the at least one additional optical component 150 may be attached on an external substrate such as a PCB. In applications such as ambient light sensors, the at least one additional optical component 150 may be omitted and the optical package 100 may comprise only one compartment 142.

It should be understood that the at least one optical component 140 may comprise optical sensor 140, and that the at least one additional optical component 150 may comprise radiation source 150. While optical sensor 140 may be disposed in at least one compartment 142, and radiation source 150 may be disposed in at least one additional compartment 152 as shown in the figures, in some embodiments, the foregoing arrangement may be reversed. Accordingly, the body 120 may comprise at least one compartment 142 where one of the optical sensor 140 and the radiation source 150 is disposed within. Similarly, for integrated package where the optical sensor 140 and the radiation source 150 are packaged in one single package, the body 120 may further comprise an additional compartment 152 for receiving the other one of the optical sensor 140 and the radiation source 150. In yet another embodiment, the optical sensor 140 may be located within the compartment 142 whereas the radiation source 150 may be attached on an external substrate such as a PCB. In applications such as ambient light sensors, the radiation source 150 may not be required and the optical package 100 may comprise only one compartment 142.

The cover 130 may be removably attachable and form-fitted onto the body 120. At least during the assembly process, testing may need to be done on various components of the optical package 100 and reworking may be required. Rework may include, but not limited to, adjusting the position of the radiation source 150 or the optical sensor 140, additionally wire bonding the optical sensor 140, or any other similar adjustment or corrective action needed after or before testing. Optionally, the cover 130 may be permanently sealed onto the body 120 upon completion of the assembly process using glue or other adhesive (not shown). As shown in FIGS. 1A and 1B, the outer shape of the cover 130 may look dissimilar to the outer shape of the body 120. However, when the cover 130 is form-fitted onto the body 120, the compartment 142 and the additional compartment 152 may be enclosed and optionally, sealed substantially. This may prevent dust from contaminating the optical sensor 140 and the radiation source 150. The substantial seal may be undone when the cover 130 is detached from the body 120.

As the cover 130 is removably attachable, an interlocking structure 122, 132 for securing the cover 130 to the body 120 may be required. The interlocking structure 122, 132 may be defined by a resilient protrusion 132 connected to the cover 130 and a mating structure 122 connected to the body 120. The interlocking structure 122, 132 usually rely on mechanical interlock mechanism and therefore may be referred as mechanical interlock. In a locked position as shown in FIG. 1B, the resilient protrusion 132 is latched on to the mating structure 122 and secures therein the cover 130 to the body 120. This arrangement may be reversed such that the resilient protrusion 132 may be connected to the body 120 and the mating structure 122 may be connected to the cover 130. The compartment 142 may be substantially sealed when the interlocking structure 122, 132 is in the locked position.

Some other mating structures using other latching mechanism may be used to secure the cover 130 onto the body 120. The optical package 100 may have more than one additional interlocking structure 122, 132. As shown in FIG. 1C, the interlocking structure 122, 132 may be located on two opposite sides of the body 120. Optionally, there may be more than one interlocking structure 122, 132 located on each side of the optical package 100.

The interlocking structure 122, 132 may be best located distanced away from the compartments 142 and 152. As shown in FIGS. 1A-1C, the interlocking structure 122, 132 may be in direct contact with one external surface 133. In some applications, the optical package 100 may remain removably attachable and may rely on the interlocking structure 122, 132 to secure the body 120 and the cover 130 together after the manufacturing or assembly process. By being removably attachable, the optical package 100 can be reconstructed, repaired or reworked for other similar purposes.

The compartment 142 or the additional compartment 152 may be defined by a ridge 124 coupled to the body 120 as shown in FIG. 1A. The ridge 124 may substantially circumference the optical sensor 140. Similarly, the ridge 124 may substantially circumference the radiation source 150. The cover 130 may comprise a ridge opposing structure 134 accommodating the ridge portion 124 such that the compartment 142 or the additional compartment 152 may be substantially enclosed when the cover 130 is form-fitted onto the body 120. Alternatively, the arrangement shown in FIG. 1A may be reversed such that the cover 130 may be connected to the ridge 124 and the ridge opposing structure 134 being connected to the body 120.

The ridge opposing structure 134 may be a sidewall of the cover 130. The ridge opposing structure 134 may also include an inner surface 138 substantially perpendicular to the sidewall as shown in the cross-sectional view illustrated in FIG. 1C. In FIG. 1C, the cover 130 and the body 120 are purposely drawn slightly space apart for clarity purpose. In the locked position as shown in FIG. 1B and FIG. 1C, the ridge 124 may engage the ridge opposing structure 134, i.e. the sidewall. Alternatively, the ridge 124 may also engage the inner surface 138. The inner surface 138 may be a portion of the ridge engaging structure 134. In some occasions, the ridge 124 may be slightly resilient such that when the interlocking structure 122, 132 is in the locked position, the ridge 124 may be pressing against the ridge opposing structure 134 and applying therein an active force that substantially seals the compartment 142 and/or 152.

The ridge 124 may have a height dimension 192 and the body 120 may have a height dimension 194. During the assembly when the cover 130 is not covering the body 120, the ridge 124 defining the compartments 142, 152 may serve as a protection wall preventing dust or other substances from contaminating the optical parts within the compartments 142, 152. During the assembly process, the body 120 and the cover 130 may be accessed by hands or equipment but the interaction is limited to the interlocking structure 122, 132 or any external surfaces that are distanced away from the compartments 142, 152. For this purpose, the ridge 124 may have a height dimension 192 that is more than 60% of the height dimension 194 of the body 120. Ridge 124 with taller dimension 192 may provide better protection than a lower one. However, a taller ridge 124 will make it difficult to access the internal portion of the compartments 142, 152.

An aperture 144 extending through the cover 130 may be arranged adjacent to the optical sensor 140. Similarly, another aperture 154 extending through the cover 130 may be arranged adjacent to the radiation source 150. The radiation source 150, the optical sensor 140, the apertures 144 an 154 may be arranged such that light emitted from the radiation source 150 may be configured to exit the aperture 154 to illuminate or incident on an external object. Reflected light may be configured to be received by the optical sensor 140 through the aperture 144. In some occasions, optical lens (not shown) may be assembled within or adjacent to the apertures 144, 154.

The compartments 142 and 152 may be filled with transparent encapsulant (not shown) such as an epoxy, silicone or any other similar material through the apertures 144 and 154. The compartments 142 and 152 may be filled with the transparent encapsulant (not shown) either fully or partially such that the radiation source 150 and the optical sensor 140 are encapsulated within the encapsulant (not shown). In another embodiment, the compartments 142 and 152 may be fully filled with the transparent encapsulant (not shown). This may permanently seal the cover 130 onto the body 120. Filling up the compartments 142 and 152 completely may prevent dust from entering the compartments 142 and 152 of the optical package 100 but reworks may become difficult. In another embodiment, the compartments 142, 152 may be partially filled up to encapsulate only the optical sensor 140, the radiation source 150 and a portion of the body 120 such that the cover 130 remains removably attachable. In yet another embodiment, the apertures 144, 154 may be filled up with the transparent encapsulant (not shown).

In order to facilitate engagement of the cover 130 to the body 120, a guiding feature 126, 136 may be utilized. The guiding feature 126, 136 may comprise a projecting structure 126 located on one of the body 120 and the cover 130 as shown in FIG. 1A. An aperture 136 accommodating the projecting structure 126 may be located on the other one of the body 120 and the cover 130. During the process of form-fitting or snapping the cover 130 onto the body 120, the projecting structure 126 may guide the cover 130 to a suitable position and engages the body 120. There may be more than one guiding feature 126, 136. The guiding feature 126, 136 is not limited to a specific shape or form illustrated in the embodiment but may also include other shapes and geometries.

The optical package 100 may form a portion of a finger navigation device. The optical package 100 may be attached on an external mounting surface (not shown). As the plurality of leads 110 may be flexible, the position of the body 120 and the cover 130 relative to the external mounting surface (not shown) where the optical package 100 is mounted may change when a force is applied to the leads 110. One way to overcome this may be by having a stopping structure 128 that may be configured to engage the external mounting surface (not shown). The stopping structure 128 may be connected to the body 120 as shown in FIG. 1A or alternatively, the stopping structure 128 may be connected to the cover 130. The stopping structure 128 may be located on two opposite sides of the optical package 100. In addition, the external mounting surface (not shown) may have a shape accommodating the stopping structure 128 such that the stopping structure 128 may also serve as a guiding feature configured to guide the optical package 100 to a desired position.

The ridge 124 or the ridge opposing structure 134 shall not be interpreted narrowly and limited to the physical form discussed above but also to include any engaging structures, shapes or geometries that can be configured to provide similar functionality. FIG. 1D illustrates a non-exhaustive list of various alternative embodiments how the ridge 124 and the ridge opposing structures 134 may be implemented other than the specific form shown in FIGS. 1A-1C. For example, the ridge 124 and the ridge opposing structure 134 may be replaced by an engaging structure 124a and a receiving structure 134a configured to form-fitting the engaging structure 124a as shown in FIG. 1D(a). In this embodiment, the engaging structure 124a may be a protruding wall and the receiving structure 134a may be a trench.

Alternatively, both the ridge 124 and the ridge opposing structure 134 may be an engaging-surface 124b of the body 120 and an engaging-surface 134b located of the cover 130 as illustrated in FIG. 1D (b). The engaging-surface 124b, 134b may be in direct contact with one another when the cover 130 is fitted onto the body 120. Likewise, as shown in FIG. 1D(c), the ridge opposing structure 134 may replaced by an internal surface 134c of a sidewall positioned in a slanted manner to engage an engaging-edge 124c of the ridge 124. As shown in FIG. 1D (d), the ridge 124 may be replaced by an engaging surface 124d substantially circumferencing at least one of the optical sensor 140 and the radiation source 150. The engaging surface 124d may be configured to engage a portion 134d of the cover 130 as shown in FIG. 1D (d), instead of the ridge opposing structure 134, as shown in FIG. 1C. The above examples are targeted for better understanding. The ridge 124 or the ridge opposing structure 134 shall not be limited to few examples illustrated, but to include any other shapes or geometries that can be configured to provide similar functions.

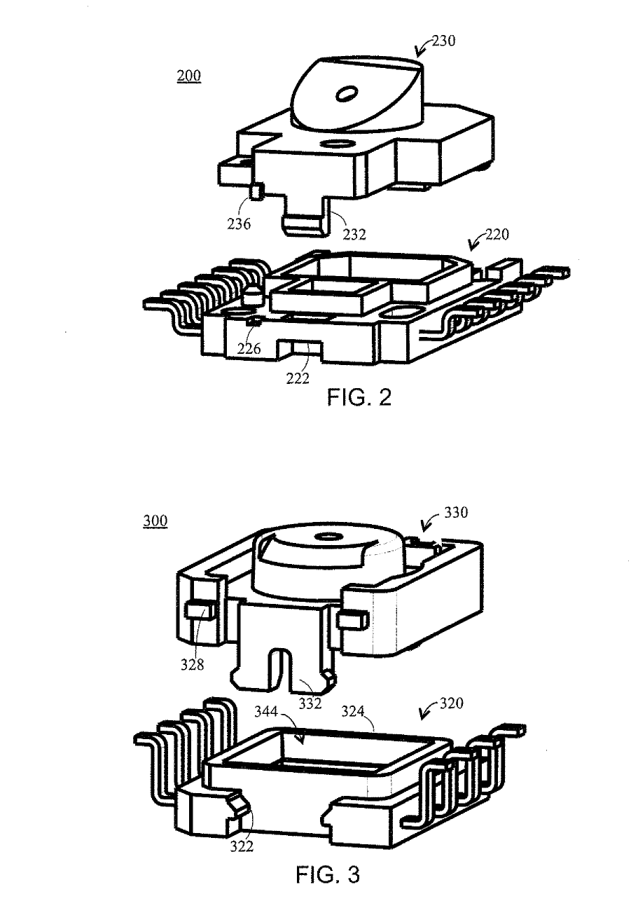

FIG. 2 illustrates an exploded isometric view of an embodiment of an optical package 200. The optical package 200 having a removably attachable cover 230 and a body 220 may be similar to the optical package 100 shown in FIG. 1A but differs at least in that the guiding feature 226, 236 of the optical package 200 has dual purposes. As illustrated in FIG. 2, the guiding feature 226, 236 comprises a protruding member 236 integral to the cover 230 and an accommodating aperture 226 defined by the body 220. The protruding member 236 has second function similar to the stopping structure 128 (See FIG. 1A) that engages an external mounting surface (not shown) when the optical package 200 is mounted on an external substrate (not shown). In addition, the interlocking structure 222, 232 is implemented differently compared to the optical package 100. The interlocking structure 222, 232 of the optical package 200 comprises a resilient beam 232 having latching structure and a latching aperture 222 to accommodate the resilient beam 232.

FIG. 3 illustrates an exploded isometric view of another embodiment of an optical package 300 having a single compartment 344. The optical package 300 comprises a removably attachable body 320 and a cover 330. As shown in FIG. 3, the body 320 comprises a ridge 324 circumference the single compartment 344. The optical package 300 further comprises an interlocking structure 322, 332 having a forked resilient beam 332 and a latching slot 322. More specifically, the forked resilient beam 332 is defined by a center recess inter-digitated with two resilient tines. The body 330 has two stopping structures 328 adjacent to the interlocking structure 322, 332 such that the interlocking structure 322, 332 may be located between the two stopping structures 328. The interlocking structure 322, 332 and the stopping structures 328 may be located on two opposite sides of the optical package 300.

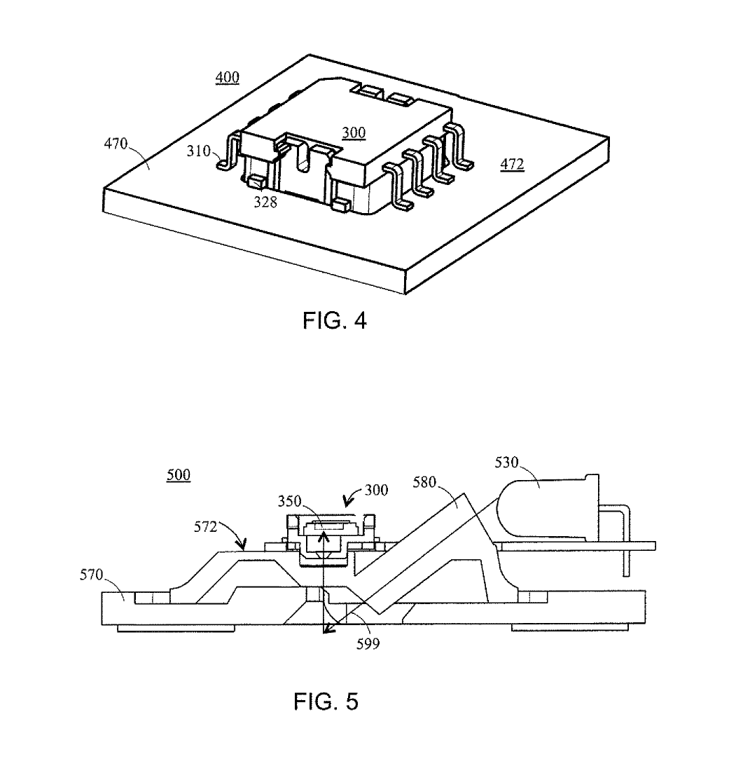

FIG. 4 illustrates how the optical package 300 is mounted on a substrate 470. The substrate 470 is a portion of an optical device having a mounting surface 472. The leads 310 of the optical package 300 may engage the mounting surface 472. However, the leads 310 may be resilient and compressible in nature. This may not be desirable for optical device as the optical performance may be affected because the distance from the sensor (not shown) to the mounting surface 472 may change. Generally, the body 300 is made from a solid material less susceptible to compression of deformation of shape. Therefore, when the stopping structure 328 of the optical package 300 engages the mounting surface 472, the distance of the optical sensor (not shown) relative to the mounting surface 472 of the substrate 470 can be maintained.

FIG. 5 illustrates a cross-sectional view of an optical mouse 500 using the optical package 300 shown in FIG. 3. The optical mouse 500 has a body 570 with a mounting surface 572. The optical package 300 is mounted on the mounting surface 572. The optical mouse 500 further comprises a radiation source 530 and a light guide 580. The radiation source 530 may be configured to emit a radiation 599 towards an external surface. The radiation 599 may be then reflected to the optical sensor 350. The optical sensor 350 may comprise an embedded processor block (not shown) having navigation processing ability to sense and compute movement information. In the embodiment shown in FIG. 5, the radiation source 530 may not be integral into the optical package 300. However, in other embodiments, an optical package similar to the optical packages 100 and 200 may be utilized so that the radiation source 530 may be integral into same package as the optical sensor 350.

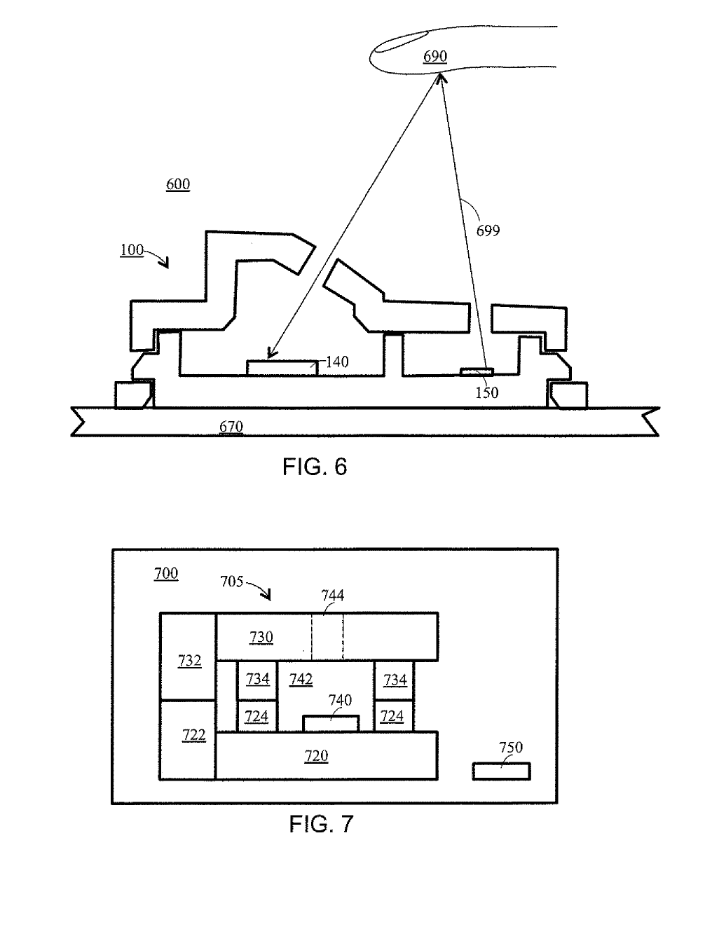

FIG. 6 illustrates a cross-sectional view of a finger navigation device 600. The finger navigation device 600 comprises an optical package 100 shown in FIGS. 1A-1C. The optical package 100 is mounted on a body 670 of the navigation device 600. The radiation source 150 may be configured to emit a radiation 699 towards an external object 690, usually a finger or a part of a finger. The radiation 699 is then reflected onto a pixelated optical sensor 140 that has a navigation processing capability to detect movement. A proximity sensor (not shown) may be constructed in a similar manner but for proximity sensing applications, the optical sensor 140 may have a different functionality to detect presence of an external object. In addition, the optical designs may be different because a proximity sensor may be configured to detect light from a range of distances and not a single distance such as finger navigation device 600.

FIG. 7 illustrates a block diagram of a device 700, which may comprise a mobile device 700. Device 700 may comprise an optical device or an optical assembly 705 suitable for an ambient light sensor or any other optical device. The optical assembly 705 comprises a body 720, a cover 730, an optical sensor 740, a mechanical interlock 722, 732 and an optional radiation source 750. The body 720 may comprise a compartment 742 extending into the body 720 for receiving the optical sensor 740. The compartment 742 may be at least partially surrounded by an engaging structure or engaging surface 724. For example, the engaging structure 724 may be a ridge shown in FIG. 1A. Alternatively, the engaging structure 744 may be a surface 124b substantially circumferencing the optical sensor 740 as shown in FIG. 1D(b).

The cover 730 may be removably attachable to the body 720. The cover 730 may comprise a receiving structure 734 accommodating the engaging structure 724. The receiving structure 734 may be any geometry or a surface located on the cover 730. The cover 730 may be form-fitted onto the body 720 such that the receiving structure 734 engages the engaging structure 724. In addition, the compartment 744 may be substantially sealed when the cover 730 is form-fitted onto the body 720. In some occasions, the engaging structure 724 may be form-fitted on the receiving structure 734. In another embodiment, the engaging structure 724 may engage a surface functioning as the receiving structure 734 such that the compartment 744 may be substantially sealed when the mechanical interlock 722, 732 is in a locked position.

The optical sensor 740 may be configured to receive light through an aperture 744 extending through the body 730. The mechanical interlock 722, 732 comprising a portion 732 attached to the cover 730 and a portion 722 attached to the body 720 may be configured to secure the cover 730 over the body 720 in a locked position. Optionally, the optical assembly 705 may further comprise an optional radiation source 750. The arrangement of the optical assembly 705 should not be limited to the block diagram but may be interchanged. For example, the radiation source 750 may be placed within the compartment 744 instead of located externally to the compartment 744.

As mentioned previously, the device 700 may comprise mobile device 700. The mobile device 700 may be a mobile phone and the optical assembly 705 may be a proximity sensor incorporated in the mobile phone. The mobile device 700 may be a portable computer or a tablet and the optical device 705 may be an ambient light sensor. Alternatively, the mobile device 700 may be a portable music player and the optical device 705 may be a finger navigation sensor. In short, the mobile device 700 may not be limited to the above combinations or examples, but may be any electronic mobile device. Similarly, the optical assembly 705 may be any optical sensing device such as optical encoder, proximity sensor, navigation sensor or any other similar optical device or optical assembly.

Different aspects, embodiments or implementations may, but need not, yield one or more of the following advantages. For example, the height of the ridge discussed in the embodiment may have the advantage of preventing dust. Likewise, although the interlocking structure may be located anywhere, but having the interlocking structure outside the compartment may facilitate reworking further away from the compartment and thus, reducing the chances of contaminating the optical sensor.

Although specific embodiments of the invention have been described and illustrated herein above, the invention should not be limited to any specific forms or arrangements of parts so described and illustrated. For example, light source die described above may be LEDs die or some other future light source die as known or later developed without departing from the spirit of the invention. Likewise, when an embodiment having an optical device was discussed, the embodiment is applicable to other component levels such as an optical assembly or an optical package to produce the optical device. Similarly, although certain orientation terms such as “lower”, “upper”, “side”, “disposed on” were used, the scope should not be limited to such orientation. The scope of the invention is to be defined by the claims.

What is claimed is:

1. An optical package, comprising:
a body;
a cover form-fitted onto the body;
a ridge portion coupled to one of the body and the cover;
a compartment defined by the ridge portion;
an optical sensor disposed within the compartment;
an aperture extending through the cover and arranged adjacent to the optical sensor;
an interlocking structure having a locked position for securing the cover to the body; and
a ridge opposing structure connected to the other one of the body and the cover for accommodating the ridge portion such that the compartment is substantially sealed when the interlocking structure is arranged in the locked position.

2. The optical package of claim 1, wherein the interlocking structure comprises;
a resilient protrusion connected to one of the body and the cover, and
a mating structure accommodating the resilient protrusion connected to the other one of the body and the cover.

3. The optical package of claim 1, wherein the ridge opposing structure for accommodating the ridge portion comprises sidewalls of the other one of the cover and the body.

4. The optical package of claim 3, wherein the ridge opposing structure comprises an internal surface of the sidewalls, of the other one of the cover and the body.

5. The optical package of claim 3, wherein the cover comprises an inner surface substantially perpendicular to the sidewalls, and wherein the ridge portion is in direct contact with the inner surface when the cover is form-fitted onto the body.

6. The optical package of claim 1, wherein each of the ridge portion and the ridge opposing structure comprises a respective surface in direct contact with one another when the cover is fitted onto the body.

7. The optical package of claim 1, wherein:
the body comprises an additional compartment; and
the cover comprises an additional aperture extending through the cover and arranged adjacent to the additional compartment.

8. The optical package of claim 7 further comprises a radiation source disposed within the additional compartment.

9. The optical package of claim 1, wherein:
the body has a height dimension;
the ridge portion has a height dimension; and
the height dimension of the ridge portion is more than approximately 60% of the height dimension of the body.

10. The optical package of claim 1, wherein the interlocking structure is distanced from the compartment.

11. An optical device, comprising:
a radiation source configured to emit a radiation;
an optical sensor configured to receive the radiation when the radiation is reflected;
a plurality of conductors electrically coupled to the radiation source and the optical sensor;
a body encapsulating a portion of the plurality of conductors;
a compartment extending into the body for receiving the optical sensor;
a cover accommodating the body;
an engaging surface at least partially surrounding the compartment; and
a mechanical interlock located outside the compartment for securing the cover to the body such that the engaging surface is covered when the mechanical interlock is in a locked position.

12. The optical device of claim 11, wherein the compartment is defined by a ridge portion of the body.

13. The optical device of claim 12 further comprising a guiding feature for aligning the ridge portion of the body to the cover.

14. The optical device of claim 11, wherein the mechanical interlock is connected to an external surface of the body.

15. The optical device of claim 11 wherein the optical device forms a portion of a finger navigation device.

16. An optical assembly, comprising:
a radiation source configured to emit a radiation;
an optical sensor configured to receive the radiation when the radiation is reflected;
a body for receiving at least one of the optical sensor and the radiation source;
an engaging-surface located on the body substantially circumferencing the at least one of the optical sensor and the radiation source;
a cover accommodating the body; and
a mechanical interlock for securing the cover to the body such that the engaging-surface is covered when the cover is secured over the body.

17. The optical assembly of claim 16 further comprises at least one stopping structure for engaging an external mounting surface.

18. The optical assembly of claim 17 further comprising at least one additional stopping structure, wherein the stopping structures are located at two opposite sides of the optical assembly.

19. The optical assembly of claim 17, wherein the at least one stopping structure is directly connected to the cover.

20. The optical device of claim 16, wherein the optical assembly forms a portion of a mobile device.
